(19) United States
(12) Patent Application Publication
(10) Pub. No.: US 2021/0405467 A1
(43) Pub. Date: Dec. 30, 2021

(54) DISPLAY DEVICE

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventor: Jida HOU, Shenzhen, Guangdong (CN)

(73) Assignee: SHENZHEN CHINA STAR OPTOELECTRONICS SEMICONDUCTOR DISPLAY TECHNOLOGY CO., LTD., Shenzhen, Guangdong (CN)

(21) Appl. No.: 16/630,892

(22) PCT Filed: Dec. 27, 2019
(86) PCT No.: PCT/CN2019/129267

§ 371 Date: Jan. 14, 2020

(30) Foreign Application Priority Data
Dec. 17, 2019 (CN) 201911302561.6

(51) Int. Cl. G02F 1/1343; G02F 1/1339; G02F 1/1335; G02F 1/1362

(52) U.S. Cl. CPC G02F 1/134345; G02F 1/1339; G02F 1/136286; G02F 1/133553; G02F 1/13439

(57) ABSTRACT

The present disclosure provides a display device, including a first substrate, a second substrate disposed opposite to the first substrate, a plurality of first sub-pixels, a plurality of second sub-pixels, a frame sealant, and a liquid crystal layer. When ambient light enters the liquid crystal layer through a plurality of first transparent electrodes on the first substrate, the front sub-pixel displaying is realized through a reflection from the surface of a plurality of second sub-pixels on the second substrate. The display device of the present disclosure does not need to provide a backlight structure, so it has low energy consumption, good heat dissipation, and is thin and light.

### FIELD OF INVENTION

The present disclosure relates to the field of display technologies, and more particularly to a display device.

### BACKGROUND OF INVENTION

Double-sided displays have broad application prospects in the fields of commodity display, electronic bulletin boards, and high-end exhibitions. Traditional liquid crystal display (LCD) double-sided display technology is implemented by two LCD display devices laminated back to back.

Since both display devices need separate backlights, and due to the design requirements of heat dissipation, the manufactured double-sided display screen has a large thickness and occupies space, which affects the look and feel. Additionally, the process is complex, the yield is low, and the production cost is high.

Therefore, the present disclosure provides a new display device, which can realize a liquid crystal screen display without a backlight structure.

### SUMMARY OF INVENTION

The object of the present disclosure is to provide a display device. The display device does not need to provide a backlight structure, so it has low energy consumption, good heat dissipation, and is thin and light.

To achieve the above object, the present disclosure provides a display device, including a first substrate, a second substrate disposed opposite to the first substrate, a frame sealant, and a liquid crystal layer, the first substrate and the second substrate are fixed by the frame sealant, the liquid crystal layer is disposed between the first substrate and the second substrate, and surrounded by the frame sealant, wherein the first substrate comprises a plurality of first sub-pixels and a plurality of first transparent electrodes disposed at intervals, the second substrate comprises a plurality second sub-pixels and a plurality of second transparent electrodes disposed at intervals, the plurality of the first sub-pixels correspond to the plurality of the second transparent electrodes, and the plurality of the second sub-pixels corresponds to the plurality of the first transparent electrodes.

Furthermore, an area of the first sub-pixel is smaller than or equal to an area of the second transparent electrode.

Furthermore, the plurality of the first sub-pixels and the plurality of the first transparent electrodes are arranged in an array, the plurality of the first sub-pixels disposed on a 2n−1th row, and the plurality of the first transparent electrodes disposed on a 2nth row, or the plurality of the first sub-pixels are disposed on 2nth row, the plurality of the first transparent electrodes are disposed on 2n−1th row; wherein n is a positive integer.

Furthermore, the plurality of the first sub-pixels are disposed with the plurality of the first transparent electrodes in an array, the plurality of the first sub-pixels are disposed on a 2m−1th column, and the plurality of the first transparent electrodes are disposed on a 2mth column, or the plurality of the first sub-pixels are disposed on a 2mth column, the plurality of the first transparent electrodes are disposed on a 2m−1th column; wherein m is a positive integer.

Furthermore, the plurality of the first sub-pixels and the plurality of the first transparent electrodes are arranged in an array, the plurality of first sub-pixels are disposed on a 2n−1th row, a 2m−1th column, a 2nth row, a 2m column, the plurality of the first transparent electrodes disposed on the 2n−1th row, the 2mth column, the 2nth row, and the 2m−1th column, or the plurality of the first sub-pixels are disposed on a 2n−1th row, a 2m column, a 2nth row, and a 2m−1th column, the plurality of the first transparent electrodes are disposed on the 2n−1th row, the 2m−1th column, the 2nth row, and the 2mth column; where n and m are positive integers.

Furthermore, the first sub-pixel comprises a metal reflective layer; the second sub-pixel comprises a metal reflective layer; and the metal reflective layer comprises a source-drain layer, scan lines or data lines.

Furthermore, the first substrate comprises a plurality of first data lines arranged vertically and a plurality of first scan lines arranged horizontally, the first sub-pixels are respectively connected to the first data line and the first scan line, the second substrate comprises a plurality of second data lines arranged vertically and a plurality of second scan lines arranged horizontally, and the second sub-pixels are respectively connected to the second data line and the second scan lines.

Furthermore, on the first substrate, the plurality of the first transparent electrodes are arranged around the first sub-pixels; on the second substrate, the plurality of the second transparent electrodes are arranged around the second sub-pixels.

Furthermore, the first substrate and the second substrate are transparent substrates.

Furthermore, the material of the first transparent electrode comprises indium tin oxide, the material of the second transparent electrode comprises indium tin oxide.

### DESCRIPTION OF FIGURES

FIG. 1 is a schematic structural diagram of a display device of the present disclosure.

FIG. 2 is a schematic structural diagram of a first substrate of the display device of the present disclosure.

FIG. 3 is a schematic structural diagram of a second substrate of the display device of the present disclosure.

FIG. 4a is a schematic diagram of a first substrate of embodiment 1 of the present disclosure.

FIG. 4b is a schematic diagram of a second substrate of embodiment 1 of the present disclosure.

FIG. 5a is a schematic diagram of a first substrate of embodiment 2 of the present disclosure.

FIG. 5b is a schematic diagram of a second substrate of embodiment 2 of the present disclosure.

FIG. 6a is a schematic diagram of a first substrate of embodiment 3 of the present disclosure.

FIG. 6b is a schematic diagram of a second substrate of embodiment 3 of the present disclosure.

### DETAILED DESCRIPTION OF PREFERRED EMBODIMENTS

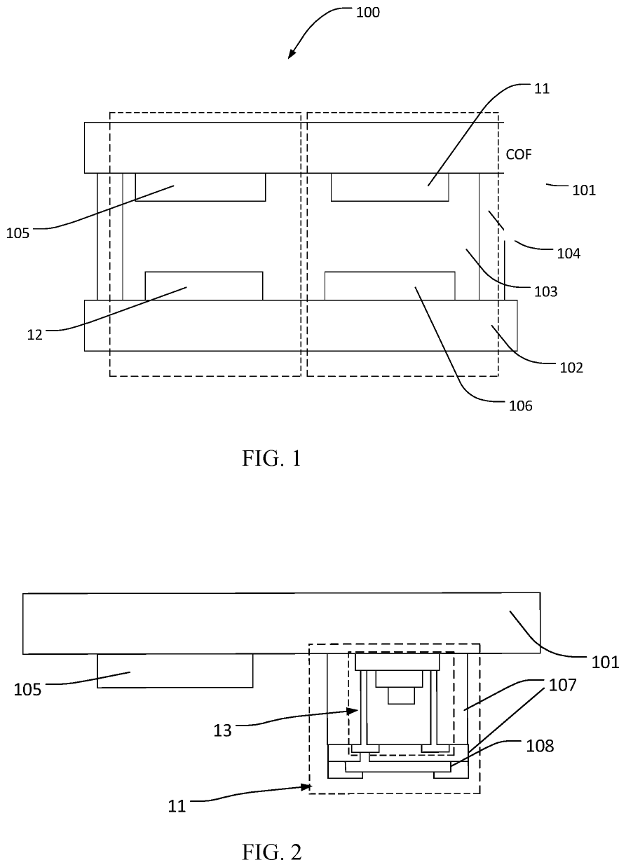

As shown in FIG. 1, a display device 100 according to an embodiment of the present disclosure includes a first substrate 101, a second substrate 102 opposite to the first substrate 101, a frame sealant 104, and a liquid crystal layer 103.

The first substrate 101 and the second substrate 102 are fixed by the frame sealant 104. The liquid crystal layer 103 is disposed between the first substrate 101 and the second substrate 102 and is surrounded by the frame sealant 104.

The first substrate 101 and the second substrate 102 are transparent substrates.

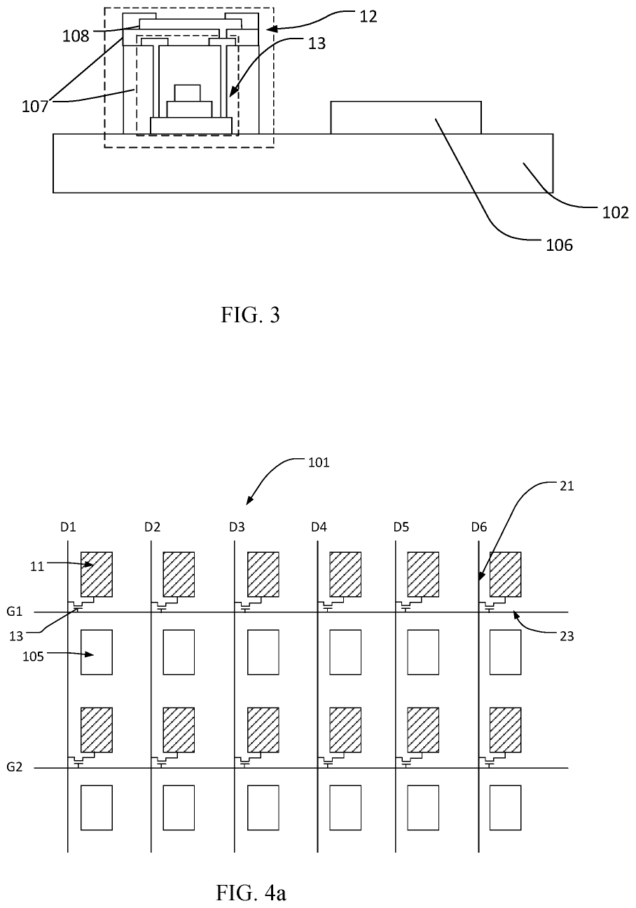

Please refer to FIG. 2 and FIG. 3. The first substrate 101 includes a plurality of first sub-pixels 11 and a plurality of first transparent electrodes 105 disposed at intervals. The second substrate 102 comprises a plurality of second sub-pixels 12 and a plurality of second transparent electrodes 106 disposed at intervals

The plurality of the first sub-pixels 11 correspond to the plurality of the second transparent electrodes 106, and the plurality of the second sub-pixels 12 correspond to the plurality of the first transparent electrodes 105.

The first sub-pixels 11 and the second sub-pixels 12 both include a dielectric layer 107 and an anode 108.

A thin film transistor 13 is disposed in the dielectric layer 107, and the anode 108 is disposed on the dielectric layer 107 and is connected to the thin film transistor 13.

The first sub-pixels include a metal reflective layer, the second sub-pixels include a metal reflective layer, and the metal reflective layer includes a source-drain layer, scan lines, or data lines configured for better light reflection.

The display device of the present disclosure is a double-sided display device, and the first substrate and the second substrate are not limited to the back surface and the front surface display.

Specifically, the first substrate 101, the first sub-pixels 11, and the second transparent electrodes 106 form a display unit configured to front or back display. The second substrate 102, the second sub-pixels 12, and the first transparent electrode 105 form a display unit configured to front or back display.

The external ambient light is incident to the liquid crystal layer 103 through the first transparent electrode 105 disposed on the first substrate 101, and the front or back display is realized by the metal reflection on the surface of the second sub-pixels 12 disposed on the second substrate 102. Similarly, the external ambient is incident to the liquid crystal layer 103 through the second transparent electrode 106 disposed on the second substrate 102, and the front or back display can be realized through the metal reflection on the surface of the first sub-pixels 11 disposed on the first substrate 101, thereby achieving double-sided display.

In the liquid crystal layer 103, liquid crystal molecules are deflected to display images by applying a voltage to the thin film transistor 13, the first transparent electrode 105, and the second transparent electrode 106.

An area of the first sub-pixel 11 is less than or equal to an area of the second transparent electrode 106. Similarly, an area of the second sub-pixels 12 is less than or equal to an area of the first transparent electrode 105, which enables more light to pass through for easy screen display.

From the perspective of the overall layout, the layout of the first substrate 101 is illustrated according to an embodiment. The plurality of the first sub-pixels 11 and the plurality of the first transparent electrodes 105 are arranged in an array. The plurality of the first sub-pixels 11 are disposed in a 2n−1th row, and the plurality of the first transparent electrodes 105 are disposed in the 2nth row, or the plurality of the first sub-pixels 11 are disposed in the 2n row, and the plurality of first transparent electrodes 105 are disposed in the 2n−1 row where n is a positive integer.

The plurality of the first sub-pixels 11 are disposed in a 2m−1th column, and the plurality of the first transparent electrodes 105 are disposed in a 2mth column, or the plurality of the first sub-pixels 11 are disposed in the 2mth column, and the plurality of first transparent electrodes 105 are disposed in the 2m−1th column; wherein m is a positive integer.

Similarly, the planar layout of the second substrate 102 is similar to that of the first substrate 101, and will not be repeated here.

The first substrate 101 includes a plurality of first data lines 21 arranged vertically and a plurality of first scan lines 23 arranged horizontally, wherein the first sub-pixels 101 are respectively connected to the first data line 21 and the first scan line 23.

The second substrate 102 includes a plurality of second data lines 22 arranged vertically and a plurality of second scan lines 24 arranged horizontally, wherein the second sub-pixels 102 are respectively connected to the second data line 22 and the second scan line 24.

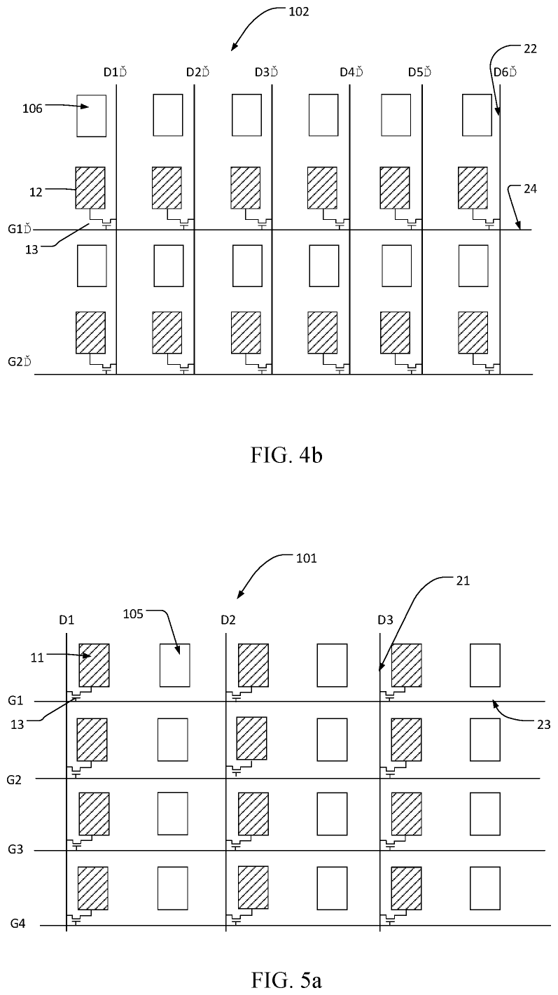

As shown in FIG. 4a, the first substrate 101 includes a plurality of first data lines 21 arranged vertically and a plurality of first scan lines 23 arranged horizontally.

In embodiment 1, the first sub-pixels 11 are arranged in odd-numbered rows, and the first transparent electrodes 105 are arranged in even-numbered rows and are disposed at intervals. In other embodiments, the positions of the two can also be switched, which does not affect the innovation point of the present disclosure.

The first sub-pixel 11 is connected to the first data lines 21 and the first scan lines 23 through a thin film transistor 13.

A gate of the thin film transistor 13 is connected to the first scan line 21, a source of the thin film transistor 13 is connected to the first data line 23, and a drain of the thin film transistor 13 is connected to the first sub-pixel 11.

Corresponding to FIG. 4a, the layout on the second substrate 102 is shown in FIG. 4b. The second substrate 102 includes a plurality of second data lines 22 arranged vertically and a plurality of second scan lines 24 arranged horizontally. The plurality of second sub-pixels 12 are arranged in even-numbered rows, the plurality of second transparent electrodes 106 are arranged in odd-numbered rows, and are disposed at intervals. In other embodiments, the positions of the two can also be switched, which does not affect the innovation point of the present disclosure.

The second sub-pixel 12 is connected to the second data line 22 and the second scan line 24 through a thin film transistor 13.

The gate of the thin film transistor 13 is connected to the second scan line 24, the source of the thin film transistor 13 is connected to the second data line 22, and the drain of the thin film transistor 13 is connected to the second sub-pixel 12.

Referring to FIG. 4a and FIG. 4b, G1 and G2 are scanning lines of two rows of sub-pixels on the front or back of the display device, D1 to D6 are data signal lines of six columns of sub-pixels on the front or back of the panel, G1′ and G2′ are scanning lines for driving two rows of sub-pixels on the back or front of the panel, and D1′ to D6′ are data signal lines configured to drive six columns of sub-pixels on the back or front of the panel. The purpose of a double-sided display of the display device is achieved by interlaced driving.

In the second embodiment, as shown in FIGS. 5a and 5b, the difference from the first embodiment are that on the first substrate 101 side, the first sub-pixels 11 are arranged in odd-numbered columns, and the first transparent electrodes 105 are arranged in even-numbered columns, and are disposed at intervals. In other embodiments, the positions of the two can also be switched, which does not affect the innovation point of the present disclosure.

On the second substrate 102, the second sub-pixels 12 are disposed in even-numbered columns, and the second transparent electrodes 106 are disposed in odd-numbered columns.

G1 to G4 are the scanning lines of the row pixels on the front or back of the display device, D1 to D3 are the data signal lines of the column pixels on the front or back of the panel, G1′ to G4′ are the scanning lines that drive the row pixels on the back or front of the panel, and D1′ to D6′ are data signal lines configured to drive column pixels on the back or front of the panel. The purpose of double-sided display is achieved by left-right interlaced driving.

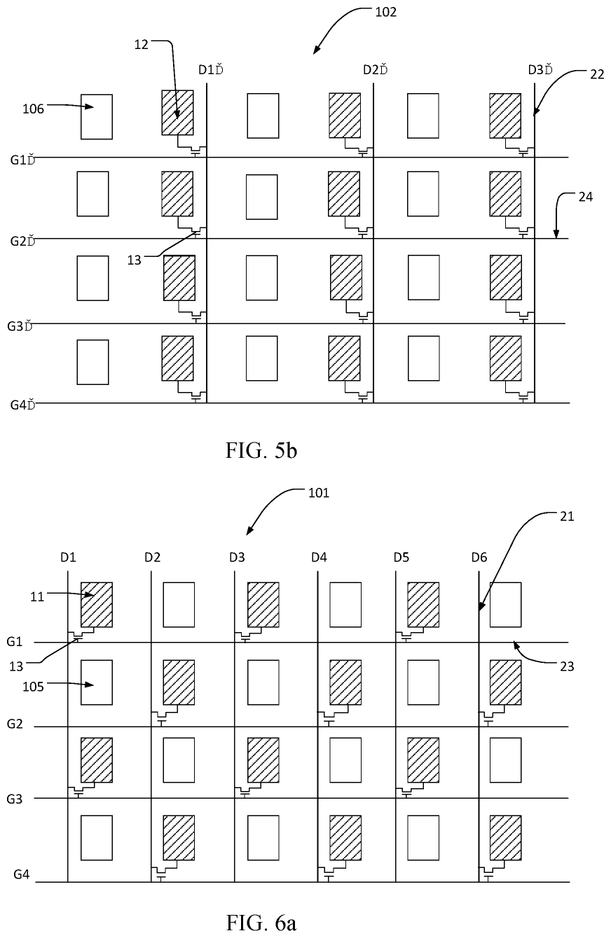

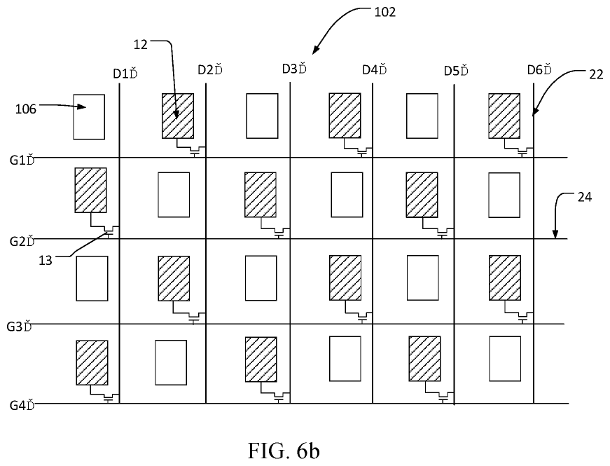

In embodiment 3, as shown in FIGS. 6a and 6b, the plurality of first sub-pixels 11 and the plurality of first transparent electrodes 105 of the first substrate 101 are arranged in an array, the plurality of the first sub-pixels 11 are disposed in a 2n−1th row, a 2m−1th column, a 2nth row, and a 2mth column, and the plurality of the first transparent electrodes 105 are disposed in the 2n−1th row, the 2mth column, the 2nth row, and the 2m−1 column; or the plurality of the first sub-pixels 11 are disposed in a 2n−1th row, a 2m column, a 2nth row, and a 2m−1 column, and the plurality of the first transparent electrodes 105 are disposed in the 2n−1th row, the 2m−1th column, the 2nth row, and the 2mth column; wherein n is positive integer.

Specifically, on the first substrate 101, the first sub-pixel 11 is surrounded by the first transparent electrodes 105 (as shown in FIG. 6a), on the second substrate 102, the second transparent electrode 106 is surrounded by the second sub-pixels 12 (as shown in FIG. 6b).

G1 to G4 are the scanning lines of the row pixels on the front or back of the display device, D1 to D6 are the data signal lines of the column pixels on the front or back of the panel, and G1′ to G6′ are the scanning lines that drive the row pixels on the back or front of the panel. D1′ to D6′ are data signal lines for driving column pixels on the back or front of the panel. The purpose of double-sided display on the display device is achieved by alternate driving of up and down, and left and right.

The thin film transistor 13 includes an oxide thin film transistor or a low-temperature polysilicon thin film transistor.

The display device 100 of the present disclosure does not need to provide a backlight structure, so it has low energy consumption, good heat dissipation, and is thin and light.

In the above embodiment, since no color filter substrate is provided, only black and white display can be performed. In other embodiments, the display device 100 further includes a first color film layer and a second color film layer, which can be used for color display.

The first color filter layer is disposed on a side of the first substrate 101 away from the liquid crystal layer 103 and corresponds to the first sub-pixel 11.

The second color filter layer is disposed on a side of the second substrate 102 away from the liquid crystal layer 103 and corresponds to the second sub-pixel 12.

For a specific embodiment of the foregoing operations, refer to the foregoing embodiments, and details are not described herein again.

It can be understood that for a person of ordinary skill in the art, equivalent replacements or changes can be made according to the technical solution and inventive concept of the present disclosure, and all these changes or replacements should fall within the protection scope of the claims attached to the present disclosure.

What is claimed is:

1. A display device, comprising a first substrate, a second substrate disposed opposite to the first substrate, a frame sealant, and a liquid crystal layer, wherein the first substrate and the second substrate are fixed by the frame sealant, the liquid crystal layer is disposed between the first substrate and the second substrate and is surrounded by the frame sealant, wherein the first substrate comprises a plurality of first sub-pixels and a plurality of first transparent electrodes disposed at intervals, the second substrate comprises a plurality of second sub-pixels and a plurality of second transparent electrodes disposed at intervals, the plurality of the first sub-pixels correspond to the plurality of the second transparent electrodes, and the plurality of the second sub-pixels corresponds to the plurality of the first transparent electrodes.

2. The display device as claimed in claim 1, wherein
an area of the first sub-pixel is less than or equal to an area of the second transparent electrode.

3. The display device as claimed in claim 1, wherein
the plurality of the first sub-pixels and the plurality of the first transparent electrodes are arranged in an array, the plurality of the first sub-pixels are disposed in a 2n−1th row, and the plurality of the first transparent electrodes are disposed in a 2nth row.

4. The display device as claimed in claim 1, wherein
the plurality of the first sub-pixels are disposed in a 2nth row, and the plurality of the first transparent electrodes are disposed in a 2n−1th row, wherein n is a positive integer.

5. The display device as claimed in claim 1, wherein
the plurality of the first sub-pixels and the plurality of the first transparent electrodes are arranged in an array, the plurality of the first sub-pixels are disposed in a 2m−1th column, and the plurality of the first transparent electrodes are disposed in a 2mth column.

6. The display device as claimed in claim 1, wherein
the plurality of the first sub-pixels are disposed in a 2mth column, and the plurality of the first transparent electrodes are disposed in a 2m−1th column, wherein m is a positive integer.

7. The display device as claimed in claim 1, wherein
the plurality of the first sub-pixels and the plurality of the first transparent electrodes are arranged in an array, the plurality of the first sub-pixels are disposed in a 2n−1th row, a 2m−1th column, a 2nth row, and a 2mth column, and the plurality of the first transparent electrodes are disposed in the 2n−1th row, the 2mth column, the 2nth row, and the 2m−1th column.

8. The display device as claimed in claim 1, wherein
the plurality of the first sub-pixels are disposed in a 2n−1th row, a 2mth column, a 2nth row, and a 2m−1th column, and the plurality of the first transparent electrodes are disposed in the 2n−1th row, the 2m−1th column, the 2nth row, and the 2mth column, wherein n and m are positive integers.

9. The display device as claimed in claim 1, wherein
the first sub-pixel comprises a metal reflective layer; and
the metal reflective layer comprises a source-drain layer, scan lines, or data lines.

10. The display device as claimed in claim 1, wherein
the second sub-pixel comprises a metal reflective layer; and
the metal reflective layer comprises a source-drain layer, scan lines, or data lines.

11. The display device as claimed in claim 1, wherein
the first substrate comprises a plurality of first data lines arranged vertically and a plurality of first scan lines arranged horizontally;
wherein the first sub-pixels are respectively connected to the first data line and the first scan line.

12. The display device as claimed in claim 1, wherein
the second substrate comprises a plurality of second data lines arranged vertically and a plurality of second scan lines arranged horizontally;
wherein the second sub-pixels are respectively connected to the second data line and the second scan line.

13. The display device as claimed in claim 7, wherein
on the first substrate, the plurality of the first transparent electrodes are arranged around the first sub-pixels;
on the second substrate, the plurality of the second transparent electrodes are arranged around the second sub-pixels.

14. The display device as claimed in claim 1, wherein
the first substrate and the second substrate are transparent substrates.

15. The display device as claimed in claim 1, wherein
material of the first transparent electrode comprises indium tin oxide.

16. The display device as claimed in claim 1, wherein
material of the second transparent electrode comprises indium tin oxide.
